(19) United States
(12) Patent Application Publication
(10) Pub. No.: US 2017/0088247 A1
(43) Pub. Date: Mar. 30, 2017

(54) ARMORED WINDOW

(71) Applicant: Sikorsky Aircraft Corporation, Stratford, CT (US)

(72) Inventor: Craig Hallquist, Vancouver, WA (US)

(21) Appl. No.: 15/126,923

(22) PCT Filed: Mar. 18, 2014
(86) PCT No.: PCT/US14/30955

§ 371 Date: Sep. 16, 2016

(51) Int. Cl. B64C 1/14; F41H 5/04; F41H 5/26; B64D 7/00

(52) U.S. Cl. CPC B64C 1/1484; B64C 1/1492; B64D 7/00; F41H 5/0407; F41H 5/263

(57) ABSTRACT

A rotary wing aircraft is provided including an airframe having a nose section located at a forward end. A window assembly is coupled to the nose section. The window assembly includes a frame and a transparent armored window. The frame has a large opening and a lip extends from a portion of the frame adjacent the large opening. The transparent armored window is formed from a plurality of layers and has a shape generally complementary to the large opening. When the transparent armored window is received within the large opening of the frame, a portion of the transparent armored window is attached to a portion of the lip.

### BACKGROUND OF THE INVENTION

Exemplary embodiments of the invention relate to a rotary wing aircraft, and more particularly, to an armored window assembly on a lower nose section of a rotary wing aircraft.

Current rotary wing aircraft incorporate a nose section having one or more windows formed therein. These windows provide one or more operator(s) of the rotary wing aircraft with a view of the area directly below the aircraft. In addition, these windows also prevent outside elements, such as dirt and debris for example, from entering into the cockpit. Typically these windows are formed from an acrylic material having a thickness generally less than 1/10 of an inch.

Rotary wing aircraft commonly fly through areas, such as war zones for example, where projectiles are aimed at the rotary wing aircraft. The current windows of the nose section are susceptible to damage from such a projectile, which may result in severe damage to the rotary wing aircraft or injury to one or more of the operators. There is therefore a need to provide a window that offers visibility of the area below the rotary wing aircraft that is also resistant to damage as a result of contact with a projectile. As with other aerospace components, there is also a desire to reduce the cost and weight of the rotary wing aircraft, and in particular, the window(s) of the nose section. Accordingly, it is desirable to provide a window which is lightweight, inexpensive, relatively simple to manufacture, and easily secured to the nose section or airframe of the rotary wing aircraft.

### BRIEF DESCRIPTION OF THE INVENTION

According to one embodiment of the invention, a rotary wing aircraft is provided including an airframe having a nose section located at a forward end. A window assembly is coupled to the nose section. The window assembly includes a frame and a transparent armored window. The frame has a large opening and a lip extends from a portion of the frame adjacent the large opening. The transparent armored window is formed from a plurality of layers and has a shape generally complementary to the large opening. When the transparent armored window is received within the large opening of the frame, a portion of the transparent armored window is attached to a portion of the lip.

In addition to one or more of the features described above, or as an alternative, in further embodiments the transparent armored window is attached to the portion of the lip with an adhesive.

In addition to one or more of the features described above, or as an alternative, in further embodiments the window assembly is curved about a first axis and a second axis. The second axis is arranged generally perpendicular to the first axis.

In addition to one or more of the features described above, or as an alternative, in further embodiments the window assembly is generally complementary in size and shape to an opening formed in a lower portion of the nose section.

In addition to one or more of the features described above, or as an alternative, in further embodiments the window assembly is mounted to the nose section, adjacent the opening with a plurality of fasteners arranged about a periphery of the frame.

In addition to one or more of the features described above, or as an alternative, in further embodiments the lip portion is generally L-shaped and includes a first portion extending generally perpendicular to a back surface, and a second portion extending generally parallel to the back surface.

In addition to one or more of the features described above, or as an alternative, in further embodiments the first portion of the lip has a length complementary to the thickness of the transparent armored window so that the front surface of the transparent armored window is substantially flush with the front surface of the frame.

In addition to one or more of the features described above, or as an alternative, in further embodiments the transparent window assembly formed from a plurality of layers includes a first layer, a second layer, and a third layer. The first layer is configured to provide a hard strike surface at a front of the transparent armored window. The second layer is formed from an adhesive thermoplastic material, and the third layer is formed from a polycarbonate material.

In addition to one or more of the features described above, or as an alternative, in further embodiments the frame and the nose section are formed form similar materials.

According to another embodiment of the invention, a method of providing a window assembly for a rotary wing aircraft is provided including forming a frame having a shape generally complementary to an opening formed in a nose section of the rotary wing aircraft. The frame includes a large opening and a lip extending from a portion of the frame adjacent the large opening. A transparent armored window configured to be positioned within the large opening is formed. The Transparent armored window includes a plurality of layers and has a shape generally complementary to the large opening. When the transparent armored window is received within the large opening, a portion of the transparent armored window is attached to a portion of the lip. An adhesive is positioned over a portion of the lip configured to contact the transparent armored window. The transparent armored window is installed into the large opening of the frame to form a window assembly curved about a first axis and a second axis. The first axis and the second axis are generally perpendicular. The window assembly is mounted to the nose section adjacent the opening.

In addition to one or more of the features described above, or as an alternative, in further embodiments forming the transparent armored window includes forming a first layer having a hard front surface, forming a second layer from an adhesive thermoplastic polyurethane material, and forming a third layer from a polycarbonate material.

In addition to one or more of the features described above, or as an alternative, in further embodiments the window assembly is mounted to the nose section with a plurality of fasteners.

According to another embodiment of the invention, a window assembly is provided including a frame and a transparent armored window. The frame has a large opening and a lip extending from a portion of the frame adjacent the large opening. The transparent armored window is formed from a plurality of layers and has a shape generally complementary to the large opening of the frame. A portion of the transparent armored window is attached to a portion of the lip.

In addition to one or more of the features described above, or as an alternative, in further embodiments the transparent armored window is attached to the portion of the lip with an adhesive.

In addition to one or more of the features described above, or as an alternative, in further embodiments the window assembly is curved about a first axis and a second axis. The second axis is arranged generally perpendicular to the first axis.

In addition to one or more of the features described above, or as an alternative, in further embodiments the lip portion is generally L-shaped and includes a first portion extending generally perpendicular to a back surface, and a second portion extending generally parallel to the back surface.

In addition to one or more of the features described above, or as an alternative, in further embodiments the first portion of the lip has a length complementary to the thickness of the transparent armored window so that the front surface of the transparent armored window is substantially flush with the front surface of the frame.

In addition to one or more of the features described above, or as an alternative, in further embodiments the transparent window assembly formed from a plurality of layers includes a first layer, a second layer, and a third layer. The first layer is configured to provide a hard strike surface at a front of the transparent armored window. The second layer is formed from an adhesive thermoplastic material, and the third layer is formed from a polycarbonate material.

Technical effects include a window assembly that is lightweight, and resistant to damage.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an example of a rotary wing aircraft;

FIG. 2 is a front view of a window assembly of a nose section of a rotary wing aircraft according to an embodiment of the invention;

FIG. 3 is a perspective side view of window assembly of a nose section of a rotary wing aircraft according to an embodiment of the invention;

FIG. 4 is a detailed view of a portion of the window assembly illustrated in FIG. 3 according to an embodiment of the invention; and

FIG. 5 is a perspective side view of an armored window of the window assembly according to an embodiment of the invention;

The detailed description explains embodiments of the invention, together with advantages and features, by way of example with reference to the drawings.

### DETAILED DESCRIPTION OF THE INVENTION

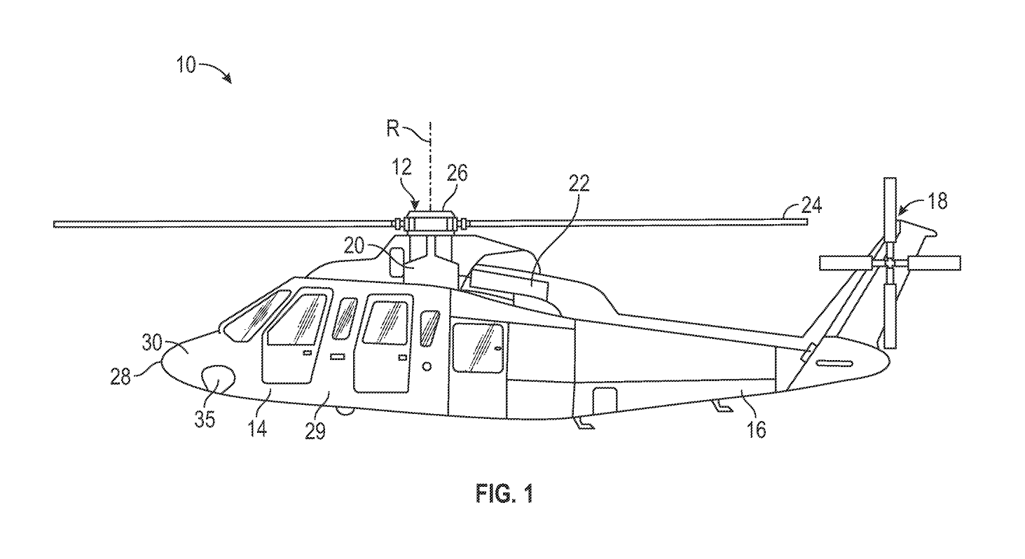

FIG. 1 schematically illustrates a rotary wing aircraft 10 having a main rotor system 12. The aircraft 10 includes an airframe 14 having an extending tail 16 which mounts a tail rotor system 18, such as an anti-torque system, a translational thrust system, a pusher propeller, a rotor propulsion system, and the like for example. The main rotor system 12 is driven about an axis of rotation R through a main gearbox (illustrated schematically at 20) by one or more engines 22. The main rotor system 12 includes a plurality of rotor blade assemblies 24 mounted to and projecting radially outwardly from a rotor hub 26. Although a particular helicopter configuration is illustrated and described in the disclosed non-limiting embodiment, other configurations and/or machines, such as high speed compound rotary wing aircraft with supplemental translational thrust systems, dual contra-rotating coaxial rotor system aircraft, turboprops, tilt-rotors, and tilt-wing aircraft, will also benefit from the present invention.

A nose section 30 of the airframe 14, arranged at a forward end 28 of the rotary wing aircraft 10 includes a window assembly 35, also referred to as a down look or chin window assembly. The window assembly 35 is positioned at a lower portion of the nose section 30 and is curved about both a first axis and a second axis. The first axis and the second axis are generally perpendicular to one another such that the window assembly 35 has a generally concave or convex shape. The window assembly 35 is configured to provide an operator of the rotary wing aircraft 10 with a view of the area generally below the aircraft 10. In one embodiment, a first window assembly 35 is arranged adjacent a first side 29 of the rotary wing aircraft 10 and a second window assembly (not shown) is positioned adjacent a second, opposite side (not shown) of the rotary wing aircraft 10 for use by a pilot and co-pilot, respectively. The first and second window assembly 35 may be substantially symmetrical about a central longitudinal axis (not shown) of the rotary wing aircraft.

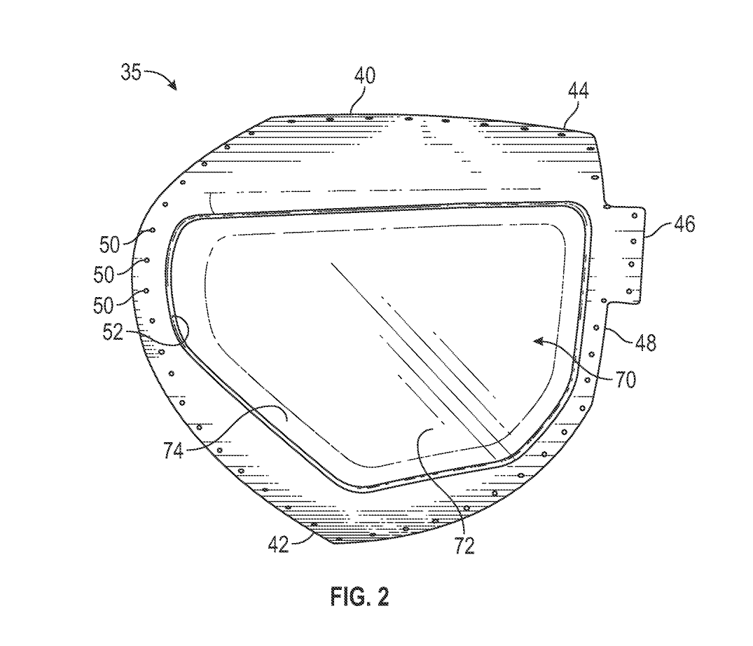

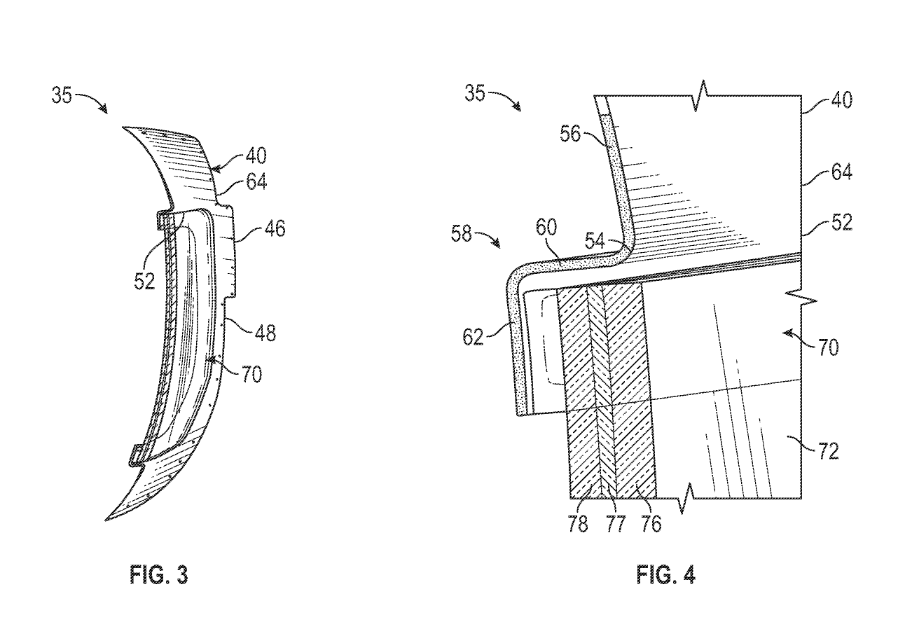

Referring now to FIGS. 2-5, the window assembly 35 of the nose section 30 is provided in more detail. The window assembly 35 generally includes a frame 40 and a transparent armored window 70. The frame 40 of the window assembly 35 is similar in shape and size to an opening (not shown) formed in the lower portion of the nose section 30. In the illustrated, non-limiting embodiment, the frame 40 includes a generally curved lower portion 42, a generally angular upper portion 44, and a tab 46 protruding from a first side 48 of the frame 40. Although a particular shape of the frame 40 is illustrated and described, a frame 40 having any shape, such as a rounded, rectangular, or polygonal shape for example, is within the scope of the invention. The frame 40 is fabricated from a rigid material, including, but not limited to carbon fiber, steel and titanium for example. In one embodiment, the frame 40 is made from the same material as the nose section 30 and/or the airframe 14 of the rotary wing aircraft 10. The frame 40 is configured to removably couple to the nose section 30, such as with a plurality of fasteners (not shown) for example, arranged in a plurality of holes 50 positioned about the outer periphery of the frame 40.

A large opening 52 configured to receive the armored window is arranged near the center of the frame 40. Extending outwardly from a portion of the frame 40 adjacent the edge 54 of the opening 52, such as the back surface 56 of the frame 40 for example, is a lip 58. The lip 58 may be extend over one or more portions of the periphery of the large opening 52, or alternatively, may extend entirely about the periphery of the large opening 52. In one embodiment, the lip 58 is generally L-shaped such that a first portion 60 of the lip 58 extends generally perpendicular to the back surface 56 and a second portion 62 extends generally parallel to the back surface 56, towards a center of the large opening 52. The second portion 62 of the lip 58 is configured to receive and support a portion of the armored window 70, such as near its periphery for example. In one embodiment, the length of the first portion 60 of the lip 58 may be generally equal to the thickness of the armored window 70 such that when the armored window 70 is positioned within the large opening 52, a front surface 72 of the armored window 70 is substantially flush with an adjacent front surface 64 of the frame 40.

The armored window 70 is generally transparent such that when the window assembly 35 is attached to a nose section 30 of a rotary wing aircraft 10, the armored window 70 provides an operator, such as a pilot or copilot for example, with a visual of the area beneath the rotary wing aircraft 10. The armored window 70 has a contour and curvature generally complementary to the frame 40. In the illustrated, non-limiting embodiment, the armored window 70 includes an angular first side 74 configured to accommodate an adjacent component of the rotary wing aircraft 10. However, an armored window 70 of any shape is within the scope of the invention.

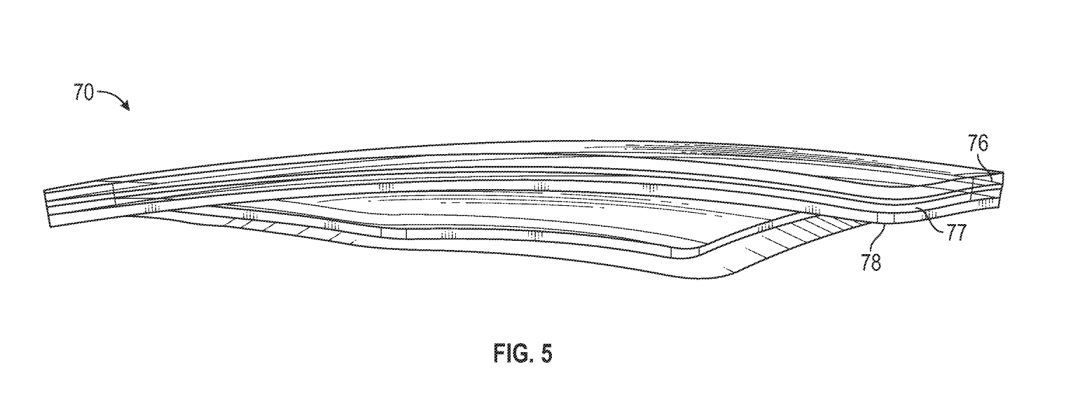

Referring now to FIG. 5, the armored window 70 is illustrated in more detail. The armored window 70 is a laminate formed from a plurality of layers. In one embodiment, a first layer 76 of the armored window 70 is formed from a material having a hard strike face, such as silica for example. An adhesive layer 77 (FIG. 4), such as formed from an adhesive polyurethane material for example, is arranged over a first surface, opposite the hard strike face of the first layer 76. A third layer 78, such as formed from a polycarbonate material for example, is attached to the adhesive layer 77, opposite the first layer 76. Although the illustrated armored window 70 includes three layers, other configurations where the window includes additional layers are within the scope of the invention. The quantity, material, and arrangement of additional layers of the armored window 70 may be selected based on a type of ballistic event that the armored window is desired to withstand.

To install the armored window 70 within the frame 40, an adhesive, such as glue for example, is positioned on the second portion 62 of the lip 58 configured to support the armored window 70. The armored window 70 is inserted into the large opening 52 of the frame 40 such that a portion of the third layer 78 is arranged over the second portion 62 of the lip 60. The strength of the connection between the armored window 70 and the frame 40 should be sufficient to withstand normal operating conditions, as well as a ballistic event or a crash.

The support that the frame 40 of the window assembly 35 provides to the armored window 70 prevents the armored window 70 from cracking when exposed to low temperatures. In addition, the window assembly 35 provides a protective barrier that is resistant to damage as a result of contact with a projectile, such as a bullet for example.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A rotary wing aircraft, comprising:
an airframe including a nose section located at a forward end of the airframe; and
a window assembly coupled to the nose section, the window assembly including:
a frame having a large opening and a lip extending from a portion of the frame adjacent the large opening;
a transparent armored window formed from a plurality of layers, the transparent armored window having a shape generally complementary to the large opening such that the when the transparent armored window is received within the large opening of the frame, a portion of the transparent armored window is attached to a portion of the lip.

2. The rotary wing aircraft according to claim 1, wherein the transparent armored window is attached to the lip with an adhesive.

3. The rotary wing aircraft according to claim 1, wherein the window assembly is curved about a first axis and a second axis, the second axis being arranged generally perpendicular to the first axis.

4. The rotary wing aircraft according to any of the preceding claims, wherein the window assembly is generally complementary in size and shape to an opening formed in a lower portion of the nose section.

5. The rotary wing aircraft according to claim 4, wherein the window assembly is mounted to the nose section, adjacent the opening, with a plurality of fasteners arranged about a periphery of the frame.

6. The rotary wing aircraft according to any of the preceding claims, wherein the lip portion is generally L shaped and includes a first portion extending generally perpendicular to a back surface of the frame and a second portion extending generally parallel to the back surface.

7. The rotary wing aircraft according to claim 6, wherein the first portion of the lip has a length complementary to a thickness of the transparent armored window such that a front surface of the transparent armored window is substantially flush with a front surface of the frame.

8. The rotary wing aircraft according to any of the preceding claims, wherein the transparent armored window formed from a plurality of layers further includes:
a first layer configured to provide a hard strike surface at a front of the transparent armored window;
a second layer formed from an adhesive thermoplastic polyurethane; and
a third layer formed from a polycarbonate material.

9. The rotary wing aircraft according to claim 8, wherein the first layer and the third layer are arranged adjacent opposing sides of the second layer.

10. The rotary wing aircraft according to any of the preceding claims, wherein the frame and the nose section are formed from similar materials.

11. A method of providing a window assembly for a rotary wing aircraft, comprising:
forming a frame having a shape generally complementary to an opening formed in a nose section of the rotary wing aircraft, the frame including a large opening and a lip extending from a portion of the frame adjacent the large opening;
forming a transparent armored window configured to be positioned within the large opening, the transparent armored window including a plurality of layers and having a shape generally complementary to the large opening such that the when the transparent armored window is received within the large opening of the frame, a portion of the transparent armored window is attached to a portion of the lip;
positioning an adhesive over a portion of the lip configured to contact the transparent armored window;
installing the transparent armored window into the large opening of the frame to form a window assembly curved about a first axis and a second axis, the first axis and the second axis being generally perpendicular; and
mounting the window assembly to the nose section adjacent the opening.

12. The method according to claim 11, wherein forming the transparent armored window includes:
forming a first layer having a hard front surface;
forming a second layer from an adhesive thermoplastic polyurethane material; and
forming a third layer from a polycarbonate material.

13. The method according to claim 11, wherein the window assembly is mounted to the nose section with a plurality of fasteners.

14. A window assembly comprising:
a frame having a large opening and a lip extending from a portion of the frame adjacent the large opening;
a transparent armored window formed from a plurality of layers, the transparent armored window having a shape generally complementary to the large opening such that the when the transparent armored window is received within the large opening of the frame, a portion of the transparent armored window is attached to a portion of the lip.

15. The window assembly according to claim 14, wherein the transparent armored window is attached to the lip with an adhesive.

16. The window assembly according to claim 14, wherein the window assembly is curved about a first axis and a second axis, the second axis being arranged generally perpendicular to the first axis.

17. The window assembly according to any of the preceding claims, wherein the lip portion is generally L shaped and includes a first portion extending generally perpendicular to a back surface of the frame and a second portion extending generally parallel to the back surface.

18. The window assembly according to claim 17, wherein the first portion of the lip has a length complementary to a thickness of the transparent armored window such that a front surface of the transparent armored window is substantially flush with a front surface of the frame.

19. The window assembly according to claim 14, wherein the transparent armored window formed from a plurality of layers further includes:
a first layer configured to provide a hard strike surface at a front of the transparent armored window;
a second layer formed from an adhesive thermoplastic polyurethane; and
a third layer formed from a polycarbonate material.
